(19) United States
(12) Patent Application Publication
(10) Pub. No.: US 2026/0141005 A1
(43) Pub. Date: May 21, 2026

(54) SYSTEM AND METHOD FOR DETECTING COPYRIGHTED MATERIAL

(71) Applicant: Innovasoft Tech Holdings Ltd, Nicosia (CY)

(72) Inventors: Samuel Marchildon-Lavoie, Sorel-Tracy (CA); Yunqiang Wei, Ottawa (CA); Joao Machado, Longueuil (CA); Patricio Page, Cordoba (AR); Bertrand Chapleau, Montréal (CA); Jose Maria Mateos Perez, Aguadulce (ES); Olivier Hillman Beauchesne, Montréal (CA)

(21) Appl. No.: 19/393,368

(22) Filed: Nov. 18, 2025

Related U.S. Application Data
(60) Provisional application No. 63/722,451, filed on Nov. 19, 2024.

(51) Int. Cl. G06F 16/951

(52) U.S. Cl. CPC G06F 16/951

(57) ABSTRACT

Systems, methods, and computer-readable storage media for detecting copyrighted material online, and more specifically to search for media content, comparing found content to known, sending notices regarding copyright infringement, and monitoring removal of the infringing material. Doing so involves the use of web crawlers to detect media content, generating fingerprints for that content, and comparing the fingerprints against known proprietary fingerprints. Once proprietary content is identified, the system can send notices out to the owner of the web site where the content was found and can continue monitoring the site until the content is removed.

### CROSS-REFERENCE

This application claims priority to U.S. Provisional Patent Application 63/722,451, filed Nov. 19, 2024, the contents of which are incorporated herein in their entirety.

### BACKGROUND

### 1. Technical Field

The present disclosure relates to detecting copyrighted material online, and more specifically to search for media content, comparing found content to known, sending notices regarding copyright infringement, and monitoring removal of the infringing material.

### 2. Introduction

One of the challenges of digital content is the ability to replicate and distribute the content without the permission of the copyright holder. This has led to widespread copyright infringement, with unauthorized copies of movies, images, books, music, and other creative works being shared across the Internet.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: at a first time: executing, via at least one processor of a computer system, a web crawler, the web crawler identifying at least one media type located on web pages of the Internet, resulting in detected media content and a web address of the detected media content; generating, via the at least one processor, a fingerprint for each piece of media within the detected media content, resulting in at least one captured fingerprint; and at a second time, the second time being after the first time: receiving, at the computer system, a catalog of proprietary media content; generating, via the at least one processor, a fingerprint for each piece of media within the catalog of proprietary media content, resulting in at least one proprietary fingerprint; comparing, via the at least one processor, the at least one proprietary fingerprint against the at least one captured fingerprint, resulting in at least one match of proprietary media content with previously identified media content; and verifying, via the at least one processor executing the web crawler, that proprietary media content associated with the at least one match is still available at the web address of the detected media content.

A system configured to perform the concepts disclosed herein can include: at a first time: executing a web crawler, the web crawler identifying at least one media type located on web pages of the Internet, resulting in detected media content and a web address of the detected media content; generating a fingerprint for each piece of media within the detected media content, resulting in at least one captured fingerprint; and at a second time, the second time being after the first time: receiving a catalog of proprietary media content; generating a fingerprint for each piece of media within the catalog of proprietary media content, resulting in at least one proprietary fingerprint; comparing the at least one proprietary fingerprint against the at least one captured fingerprint, resulting in at least one match of proprietary media content with previously identified media content; and verifying, by executing the web crawler, that proprietary media content associated with the at least one match is still available at the web address of the detected media content.

A non-transitory computer-readable storage medium configured as disclosed herein can have instructions stored which, when executed by at least one processor, cause the at least one processor to perform operations which include: at a first time: executing a web crawler, the web crawler identifying at least one media type located on web pages of the Internet, resulting in detected media content and a web address of the detected media content; generating a fingerprint for each piece of media within the detected media content, resulting in at least one captured fingerprint; and at a second time, the second time being after the first time: receiving a catalog of proprietary media content; generating a fingerprint for each piece of media within the catalog of proprietary media content, resulting in at least one proprietary fingerprint; comparing the at least one proprietary fingerprint against the at least one captured fingerprint, resulting in at least one match of proprietary media content with previously identified media content; and verifying, by executing the web crawler, that proprietary media content associated with the at least one match is still available at the web address of the detected media content.

### BRIEF DESCRIPTION OF THE DRAWINGS

FIG. 1 illustrates an example system embodiment;

FIG. 2 illustrates an example of the crawler portion of the system;

FIG. 3a illustrates a first example of the detection portion of the system;

FIG. 3b illustrates a second example of the detection portion of the system;

FIG. 4 illustrates an example of the updater and user interface portions of the system;

FIG. 5 illustrates an example of the notifications portion of the system;

FIG. 6 illustrates an example of an ingestion flow to the system;

FIG. 7 illustrates an example method embodiment;

FIG. 8 illustrates an example view of a dashboard for using the system;

FIG. 9 illustrates an example view of the content database tab in the dashboard;

FIG. 10 illustrates an example view of the crawl sites tab in the dashboard;

FIG. 11 illustrates an example view of the removal tab in the dashboard; and

FIG. 12 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

Systems configured as disclosed herein find, analyze, and enforce copyright protections on content (or collections of content) such as videos, images, books, music, and brands found online. In some configurations, the system can be configured to search for only a specific type of content (e.g., only videos). The system finds content such as videos, images, music, etc., and/or metadata associated with the content (e.g., description, title, tags, actors, categories, brands, etc.) online, and compares the content and/or metadata to known content using fingerprints, or by matching keywords appearing on the webpage where the content is appearing (e.g., descriptions of a video). If the comparison indicates that the content is being infringed, the system generates and sends legal notices to those hosting the content. After sending the legal notices, the system can monitor the removal of the infringing material, verifying that the content has been removed.

To find the content on servers across the Internet, the system utilizes a web crawler. The crawler (for example, a JavaScript crawler) crawls web pages using headless browsers (GOOGLE CHROME, FIREFOX, etc.). The crawler receives crawl requests to interact and extract metadata from the web pages they crawl. They can also take screenshots of the web pages. The JavaScript crawlers can be hosted in multiple physical regions (e.g., Canada, United States, England, Germany, etc. ). The system operates according to predefined flows, which are groups of components that achieve specific goals, the specific goals defined by a system user or administrator. These flows may, in some configurations, be separate modules, programs, or algorithms. The crawler flow causes the web crawler to crawl web pages on demand or at a specific interval. How pages are crawled depends on per-domain and global configuration. The crawler aims to crawl new web pages to find videos, images, or brands stored on a database or available through the web pages. Collections of one or more types of content can also be crawled and analyzed (a collection being a database, folder, or other storage location having one or more videos/images associated with an actor, associated with a company/brand, associated with a location, etc.). In addition, collections of content may be a group of content being protected by the system.

In some instances, content can be owned or managed by one or more entities, each having different permissions, licenses, etc. associated with the content owned and managed by the different entities. These entities can also be hierarchical, where some companies are subsidiaries of the parent company. In such cases, the parent company may have an overall policy which applies to the collective/collection of companies in the absence of policies of the subsidiaries. Consider the following example. Company A owns subsidiary companies B and C. Companies A, B, and C each have their own content being managed or licensed, and may have separate brand names or trademarks associated with their respective content. When systems configured as disclosed herein are reviewing content and permissions associated with that content, the system can identify content owned by subsidiary B. The system can then determine if the domain has a policy/license to be hosting the content from subsidiary B. If subsidiary B does not have a policy/license, the system can consider if the parent company, company A, has a policy in place which governs how the hosting of this content should be viewed.

The crawler flow operates using one or more of a crawling engine (e.g., stormcrawler, an open-source, modular web crawler), a JavaScript router, JavaScript crawlers, a proxy router, and proxy nodes.

A stormcrawler is an open-source web crawler system. In other configurations, the web crawler can be closed source or an otherwise private web crawling algorithm. It schedules the web pages to crawl, processes the content of the web pages, and updates the status of those web pages in a database. The stormcrawler will connect to the JavaScript router and/or the proxy router to crawl the web pages based on domain settings. The domain can be configured to either use the JavaScript or proxy routers. The choice between JavaScript or proxy routers is not automatic and can depend on if the site requires JavaScript or not.

The JavaScript router is a routing system for the JavaScript crawlers. The goal of the routing system is to route the crawl requests to available JavaScript crawlers in different regions to optimize the number of concurrent requests the system can handle. A region can be defined geographically, but not necessarily. For example, distinct cloud providers can result in distinct regions.

The proxy nodes are Hypertext Transfer Protocol (HTTP) proxies hosted in multiple physical regions (Canada, United States, England, Germany, etc.). They receive HTTP requests and forward them to their final destination.

The Proxy Router is the routing system for the Proxy Nodes. The goal is to route the http requests to available proxy nodes in the different regions to optimize the number of concurrent requests the system can handle.

Following the crawler flow, a detection flow analyzes the videos, images, and/or brands (depending on configuration) found by the crawler flow. Each domain name (e.g., a Uniform Resource Locators (URL) has its own configuration stored within the system describing how new videos, images and brands found should be matched. For example, if a domain is configured to use metadata detection, the system can use the metadata (titles, author, etc.) found and compare it to a database of metadata (stored within the system, or in communication with the system) of all the copyrighted materials known to the system. Likewise, if a domain is configured to use hash detection, the videos (or other content captured, such as but not limited to images) can be compared using different Artificial Intelligence (AI) algorithms which use one or more of video, image, audio, and/or keyframe fingerprints to match audio and frames known copyrighted materials. For example, from a video the system can extract both visual and audio fingerprints. After comparing downloaded content against a catalog of copyrighted content, potential matches (e.g., those having more than a predefined level of similarity) are retrieved, the best matches are identified, and the system can determine if the downloaded content is the same as the known, copyrighted content (i.e., if the content infringes on a known copyright holder's rights).

This determination regarding potential copyright infringement can be based on a set of rules, such as but not limited to: does the domain hosting the video, image and/or metadata have permission to do so? ; what rules or instructions has the company owning the copyrighted material provided? ; what rules or instructions are associated with the brand owning or distributing the copyrighted material?. A common example of a rule is ‘uploader whitelisting’, where known affiliates (i.e., third parties) might be allowed to upload proprietary/licensed videos on external domains, where those videos should not be identified as infringing. Based on these rules the system can determine if the match is infringing or not. An infringement decision means the domain hosting the material shouldn't be hosting this content (i.e.: it is infringing). Components for the detection flow can include (for detection of content): a downloader manager, one or more downloaders, a pre-processor, a hashing receiver, a hash loader, and/or a match decision. The detection flow can also include (as a non-limiting example), for detection of metadata, metadata detection (e.g., an infringing detector).

The downloader manager generates orders regarding which videos to download. Based on domain configuration, it can order the videos to download next based on priority, domain capacity, region capacity and/or previous download status.

The one or more downloaders download videos from web pages. They receive a web page with a set of actions on how to find and download the videos. Because every domain is different, the instructions sometimes need to be tailored to that specific domain, e.g.: “aim for the lowest available downloadable resolution”, “only download the first X minutes of a video”, “perform those java script instructions to be able extract the video”. The downloaders receive the URLs of the videos to download from the downloader manager and can be hosted in multiple physical regions (e.g., Canada, United States, England, Germany, etc.).

The pre-processor processes the videos from the downloaders into the formats required for the comparison/content matching engine. For example, the system may (depending on the configuration) convert content (e.g., video or images) to greyscale, crop or otherwise resize the content, etc. In addition, the pre-processor can generate fingerprints of the content. Such fingerprints can be hashes or other known mechanisms for identifying content.

The hashing receiver acts as a middleman between the fingerprinting engine and the match decision (aka hashing loader). The fingerprinting engine receives the pre-processor processed videos generated by the pre-processor. The hashing receiver sends the video fingerprints computed in the pre-processor to the fingerprint comparison engine, and the fingerprint comparison engine matches the fingerprints to known content. The fingerprint comparison engine returns the results to the hashing receiver which interprets the results and packages those results for the match decision component.

The match decision processes the comparison results into an infringement decision. Based on the matches, best match, domain settings and global rules, the hashing-loader will decide if a web page is hosting infringing material.

When infringement is determined based on metadata, the system can further use a metadata detector (aka an infringing detector), which compares metadata extracted when crawling web pages and the metadata of known content stored in the system's database. The metadata detector tries to find potential matches and determines, based on the matches, best match, domain settings, metadata, and global rules if a web page is hosting infringing material. For example, a video page might show the title of the video and the names of the actors present in the video. If those are deemed close enough by the metadata detector to a known, proprietary video, the system will consider the video as potentially infringing. Further comparison of the video fingerprints to known fingerprints, and/or human review, can lead to a determination that the video is infringing.

Once content has been determined to be infringing, the system can initiate a notification flow, generating and sending a notification regarding the infringing content to an owner of the website. The notification flow sends Digital Millennium Copyright Act (DMCA) (or, in non-U.S. jurisdiction, comparable copyright law) notices to the domain owners that are hosting infringing videos, images and/or brands. The notification flow uses the infringing best matches found in the detection flow to send DMCA notices. Before sending the notices, the notification flow can take screenshots of the infringing content and can verify the metadata of the web pages hosting the infringing materials, thereby ensuring that the web pages are still hosting the infringing materials. The system will send the domains hosting the infringing material DMCA notices at regular intervals for all the infringing materials they are hosting. The number of notices sent per infringing material and domain can be configured on a domain, company, and/or brand basis.

The notification flow can include: an email notice, a shooter, the crawling engine (which can use proxy or JavaScript crawlers depending on domain configuration), and/or an evidence service.

The email notice can be an algorithm, module, or other aspect of the system. The email notice sends DMCA notices to the domains hosting infringing material. The email notice can send these emails at periodic intervals based on the domain settings, brand settings, company owning the brand settings, and/or the number of infringing materials. In addition, an email notice can trigger links to be checked with a priority based on the domains, the content detected, the brand, the company name, number of infringing materials, etc.

A shooter (i.e., a screenshot software or screen capture tool) captures screenshots of web pages hosting infringing material to have proof that the content is hosted. In this manner the system can capture pictures/evidence of the infringement and can create evidence packages in case legal action is required (i.e., an evidence service). The evidence service can store the multiple pieces of evidence (screenshots, emails, video animations) collected by the system while monitoring infringing domains. To browse to the infringing content (and to verify that the domain didn't simply move the content to another location) the crawling engine can be used to verify if a given URL on which the system previously detected infringing content is still accessible (and if the metadata, e.g., uploader name, description, etc., is still up to date).

Once one or more notifications have been sent to infringing domain, the system can begin checking (via a checker-updater) the infringing domain to see if the content is still available using an updater flow. The updater flow updates the metadata of all the infringing material found in the detection flow. At regular intervals, the updater flow (using the crawling engine) can crawl the web pages hosting the infringing materials to update the metadata and ensure that the infringing materials has been removed. Once the infringing materials have been removed, the updater flow can continue to monitor web pages to make sure that the materials were not reuploaded. The intervals to update and monitor the web pages can be configured per domain. Components of an updater flow can include: a checker-updater, a component named the crawler-Application Programming Interface (API) (used to interact with the crawling engine), and/or a component named an extractor (used to find URLs to update/crawl). The crawling engine is also part of the updater flow.

The crawler-API can schedule the Uniform Resource Locators (URLs) to be crawled per domain. The crawler-API has the capacity to inject new URLs in the system (i.e., it can inject URLs to be crawled by the web crawler).

The extractor schedules the URLs to be updated by the checker-updater.

An additional flow, the ingestion flow, ingests the content (e.g., videos, images, music, etc.) that need to be protected by the system. The copyright owners of the content can enable and disable the protection and update the metadata of their materials. The content is then ingested by the content matching engine (which generates fingerprints and compares newly found content to known content). The content metadata (e.g., title, authors, etc.) can also be stored in a database.

In some configurations, the system can backscan sites that were previously crawled when/if new copyrighted content is added. In other words, if the system onboards a new catalog of copyrighted content, the system does not need to crawl and redownload videos from sites it already crawled—instead, the system only needs to query its historical database of scanned content. In this manner, initially the system knows nothing about party ‘A’ who is hosting infringing content. The fingerprint engine has a copy of the fingerprints of previously found content for each domain. When party ‘A’ ingests new content into the system to now be protected, the system will query all the fingerprints stored in one or more historical databases and try to find matches for party A's content. This avoids the need to re-crawl domains from scratch when new content is protected content (i.e., should be removed). If the content is still present, the system can generate notifications using the notification flow disclosed above.

Consider the following example. The system, using a web crawler, identifies content (e.g., images, videos, music, books, etc.) on the Internet, and records a location (e.g., the URL hosting the content) associated with each piece of content. For each piece of content found, the system generates a fingerprint representing that content. For example, the fingerprint can be a perceptual hash of the content. In the case of a video, the video may be pre-processed (e.g., resized, converted to greyscale, sampled, etc.), and the processed video can then be hashed using a perceptual hash or other fingerprinting mechanism. A perceptual hash can be useful since a perceptual hash allows the system to determine if analogous features in the content are similar (e.g., via a similarity function). Likewise, in the case of an image, the image can be pre-processed, then a perceptual hash can be generated using the pre-processed image.

Later, after the system has scanned the web and fingerprints have been generated, the system can receive a new catalog of proprietary (e.g., copyrighted) content. The system can generate, for each piece of content in the newly received catalog, a fingerprint, and compare the fingerprints of the new catalog against the previously collected fingerprints of content available on the Internet. If there is a match (meaning that the content should have been previously flagged as proprietary), the system can verify that the proprietary content is still available on the Internet by downloading the content again. In some configurations, the system may execute additional fingerprinting on the downloaded content to further verify the match exists. If the match exists, the system can follow the rules associated with that content (i.e., the rules put forward by the owner of that content). For example, the system can generate a letter (e.g., a cease-and-desist letter or other notification of infringement) for the owner of the web address where the content is available, the letter informing the owner that the proprietary media content should be removed. In some configurations, the system can provide flags or notices to human beings for further review, can automatically takedown the infringing content, and/or inform legal authorities of the violation.

In some configurations, when infringing content, such as an infringing video, is found, the system can generate an image/video animation for each match. Non-limiting examples of such image/video animations can include a Graphics Interchange Format (GIF) or a webM (an open media file format) for each match. The image/video animation can show in a few frames the specific video in question, and this can be printed or emailed to the domain owner hosting the content being illegally shared (i.e., providing proof that the content is present, and illustrating the exact content in question.

To determine if a piece of content is being illegally shared, the system must determine if the content is the same content, or sufficiently similar to, known/previously analyzed content. While if the content is exactly the same such a determination is relatively straightforward, in some cases the system may need to determine how similar found content is to known content, then determine if the content is sufficiently similar to determine that there is likely infringement. For example, the predetermined percentage of similarity can be at least ten percent similarity of video or twenty percent similarity of audio.

To be more computationally efficient, the system disclosed herein can vary how the web crawlers operate. For example, the system can execute a priority crawl which is executed periodically (e.g., every day, every week, etc.) on a specific web page to identify newly uploaded content (e.g., the “New” page of a given website), and a general crawl which, when executed, crawls all web pages associated with a domain. In this manner, the system can proactively examine the locations where newly uploaded content is likely to be found but still run a more general search for all content.

In some configurations, the system can be configured to allow automatic domain disabling upon detection of infringing content. For example, the system can detect if a domain fails systematically on downloads and can automatically disable the domain to allow a user to investigate.

Likewise, in some configurations the system can automatically determine if a domain is protected by a Content Delivery Network (CDN) and/or reverse proxy cloud provider. Such services may act as a firewall, filtering out malicious traffic and protecting the website/domain from threats like Distributed Denial of Service (DDoS) attacks and bots. Non-limiting examples of such CDN and/or reverse proxy cloud provider include CLOUDFARE. Based on the detection of a CDN and/or reverse proxy cloud provider, the system can manage how the domain is monitored at the configuration stage of the domain.

In some configurations, the system can provide the ability for a collection entity publishing content from multiple brands or companies to own content to protect or own other collections. In such configurations, the system can use decision rules to determine how the system responds upon detection of infringing content. These decision rules can be based on the collections owning a piece of detected infringing content and can be executed in a hierarchical manner.

In addition to identifying copyrighted or otherwise proprietary materials, the system can be configured to identify counterfeit goods based on images or video. For example, the system can have stored fingerprints based on known, authenticated goods or products. When the system is crawling the Internet, it may detect a product claiming to be authentic, but upon review of the photographs provided by the seller the system may determine that the goods being sold are fake or otherwise counterfeit. For example, a clothing manufacturer may provide the system with images and/or video of clothes, and based on the images/video the system can create fingerprints associated with the clothing. The system can then crawl the web and, upon detecting someone offering the clothing for sale (e.g., on an e-commerce website), the system can capture the photos uploaded by the seller of the clothing, generate fingerprints of the seller's photos, and compare those fingerprints against the fingerprints of the known/authenticated clothing. If the fingerprints do not match the product being sold may be marked as a forgery/counterfeit, removed from sale, a notice may be sent to the seller, etc. In cases where the product is being sold on a website with the ability to report fraud, the system can automatically initiate and/or complete that reporting, complete with pictures supporting the counterfeit analysis.

Systems configured as disclosed herein use proprietary fingerprinting and safeguard technology to crawl designated third-party sites and identify content that has been flagged as protected or violative material. The system compares previously fingerprinted content against material identified on third-party platforms to detect potential matches. When matching content is found, the system generates and sends Digital Millennium Copyright Act (DMCA) notices for removal, tracks URLs, and issues follow-up notices if the content remains accessible.

A compliance support team can integrate with this system by providing manual takedown services for complex cases or specific client-directed exceptions where content should not be removed. In other cases, the takedown process can be automated.

Industries such as media and entertainment companies, as well as online marketplaces, can use this service to detect and request the removal of copyrighted or infringing material. The system can be configured to identify protected works such as film or television content, or to locate counterfeit goods on online marketplaces. In this case, the “user” would function as a member of the content compliance team.

Consider the following example of a system user. The user can upload a client's (or an entity's) original or copyrighted materials to a designated library in the platform dashboard for fingerprinting. The client specifies where they would like the initial web crawling to begin. The user enters website-specific details regarding the initial crawling locations. The user and client determine the frequency (e.g., every 4 hours) at which the system should crawl these sites to identify copyrighted content. Once the frequency is set, the system crawls the designated sites. The content found on those sites is compared against the client's original or copyrighted content library to detect matching material. The system alerts the user when matching content has been detected. The user reviews the matching content to determine whether removal is warranted. The user initiates a semi-automated content removal sequence (e.g., multiple automated requests) for confirmed infringing material. The user can modify the content removal request letter to reference specific platform policies when needed. The user can search across all detected matching content for each client. The user can download visual reports showing the volume of matching content identified, removal requests made, number of requests submitted, and overall takedown status. The system tracks URLs to verify whether content removal has been successful. If automated removal attempts are unsuccessful, the user initiates a formal escalation process to the legal team for manual action.

Media and entertainment organizations (e.g., film studios, television networks, music labels) can use the system to identify potential copyright violations and automatically submit takedown requests. For example, the system can fingerprint an artist's original work, such as a music video, and the system would detect unauthorized re-uploads of the same content and automatically issue DMCA removal requests.

Online marketplaces can use the system to detect and request the removal of counterfeit goods listed on their platforms. If requested by the marketplace or the original brand owner, the system could collect information on counterfeit listings for potential reporting to law enforcement.

Individual users—such as independent photographers, artists, or content creators—can use the system to determine whether their original content has been copied or used without authorization.

Consider the following example process flows:

### Fingerprinting and Content Ingestion

The user uploads the client's original content into a secure and protected database.
The fingerprinting technology analyzes the content using metadata extraction, perceptual hashing, mathematical abstraction, facial recognition, and/or multi-layer audio analysis.
Each piece of content is assigned a unique hash identifier (i.e., fingerprint).
The user is provided with a progress indicator showing the status of fingerprinting for each uploaded file.
The user can search for specific fingerprints within a centralized database under each client's dashboard tab.

### Identification and Configuration of Crawling Sites

The user identifies initial websites to be crawled—those most likely to contain potentially matching content.
The user enters required details about each site into the dashboard, including the desired crawl frequency.
The user can monitor the real-time status of crawling activity for each site within the dashboard interface.

### Content Registration and Detection

The system identifies potentially matching content on designated sites during scheduled crawl intervals.
The user can review each identified match before any automated content removal requests are triggered.
The dashboard displays the percentage of similarity between detected content and the client's original material.

### Content Removal Workflow

The user can manually determine whether automated content removal requests should be initiated (and how many times), whether manual removal should be pursued, whether no action should be taken, or whether the match was incorrect.
Once removal requests are submitted, the user can view their real-time status through the dashboard.
The user has the ability to modify removal request templates for each client to include customized language or platform-specific references.
If all automated removal attempts fail, the system notifies the user so the issue can be escalated to the legal or compliance team for further action.

### Logging and Audit Trail

The dashboard includes back-end logging capabilities to document all actions taken by the compliance operations team, providing a verifiable audit trail for internal and external investigations.

### Reporting and Analytics

The user can export results in visual formats to demonstrate the total volume of matching content identified, the number of removal requests made, and the overall success rate of content removals.

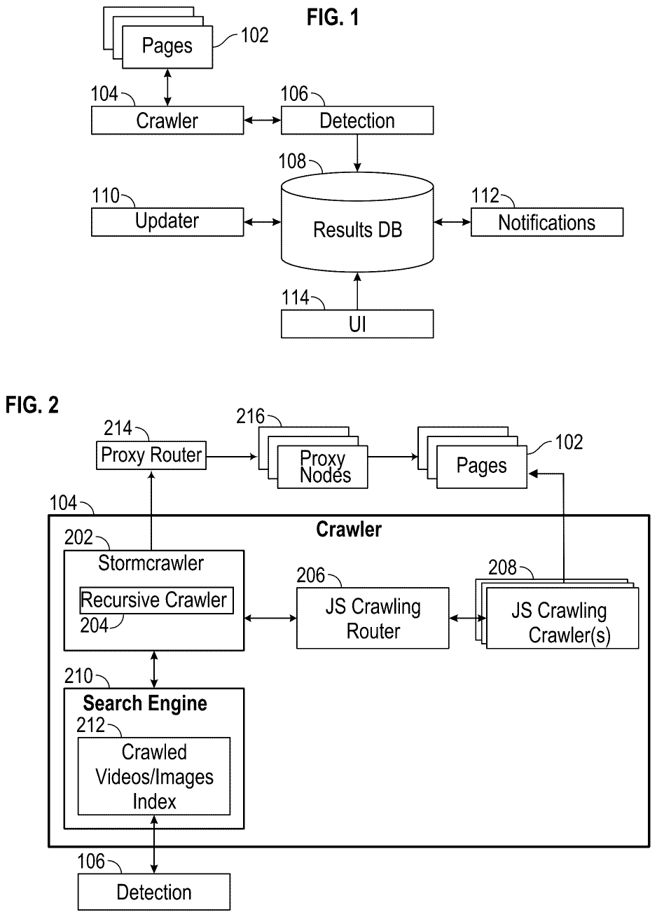

FIG. 1 illustrates an example system embodiment. As illustrated, the system includes a crawler 104 which navigates web pages 102. The content identified by the crawler 104 undergoes a detection 106 flow, with fingerprints stored in the fingerprint engine database (DB) 108. A separate results database stores the results, e.g., “URL XYZ is infringing and matches video ABC.” An updater 110 determines if the infringing content identified by the detection 106 flow is still available or has been removed, and if present notifications 112 can be generated to an owner of the website or web pages 102 where the content was found. The system also has a user interface 114, allowing a network administrator or other use to modify settings and otherwise interact with the system as needed.

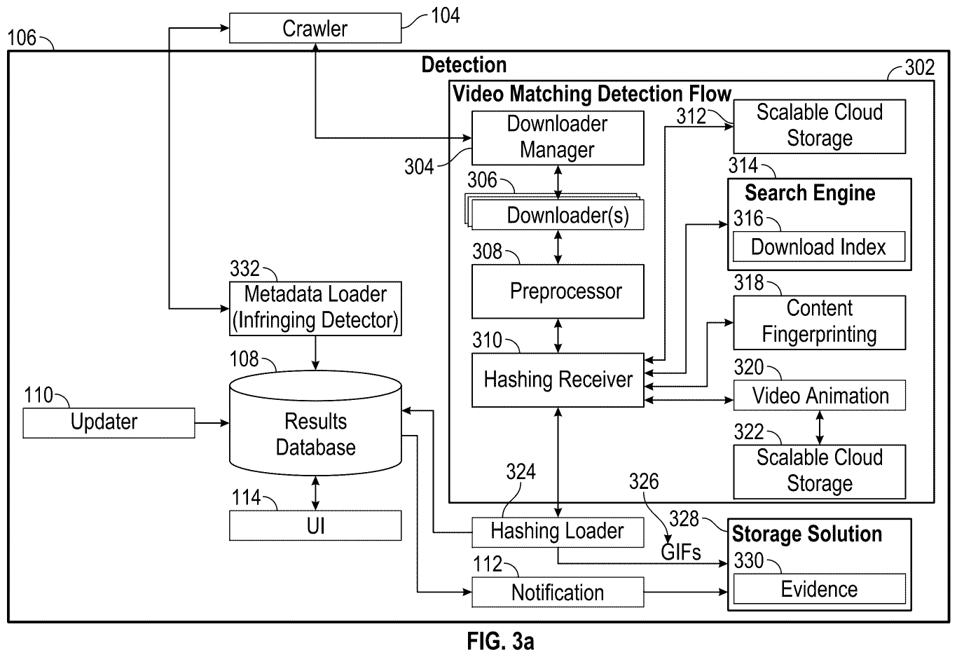

FIG. 2 illustrates an example of the crawler 104 portion of the system. Here, the crawler 104 again interacts with the web pages 102 and the detection 106 flow. The crawler 104, using a recursive crawler 204 directed by a Storm Crawler 202, interacts with a JavaScript (JS) crawling router 206, which directs one or more JS crawling crawlers 208, which also examines the web pages 102. While the recursive crawler 204 will make the decision to visit page X or Y as it recursively crawls pages, it forwards the actual web requests to either the JS crawler 206 or a HTTP proxy. In essence, Storm Crawler (SC) 202 is the brain, and the one or more JS crawling crawlers 208 and proxy nodes 216 are the eyes. Storm Crawler 202 never interacts directly with web pages 102, instead sending instructions through either the one or more JS crawling crawlers 208 (through the JS crawler router 206) or the Hypertext Transfer Protocol (HTTP) proxy nodes 216 (through the corresponding proxy router 214), depending on the configuration of the domain to be crawled. The proxy nodes 216 receive HTTP requests from a client and only proxy the request. The purpose of the proxy nodes 216 is to hide the original Internet Protocol (IP) addresses. The one or more JS crawling crawlers 208 load a web page in GOOGLE CHROME (headless, i.e., in an unattended environment, without any visible User Interface (UI)) and can interact with the web page 102 like human would with a browser. The one or more JS crawling crawlers 208 can extract metadata and do actions on the web page 102.

The results from the stream processing (i.e., the Storm Crawler 202) are input into a search engine 210, using a crawled videos/images index 212 (and/or any additional types of content, such as books, music, etc.). The results of the search engine 210 (i.e., the search results of a text-based search engine) can then be forwarded to the detection 106 flow.

Consider the following example of what happens when crawling URLs. The storm crawler 202 (SC) receives multiple URLs, e.g. somedomain. com/newestvideos/0. The storm crawler 202 obtains the domain config of somedomain. com, then begins crawling the URL. If the storm crawler 202 uses a proxy, it sends one or more HTTP requests to the proxy router 214. The proxy router 214 sends a request to one or more proxy nodes 216, which in turn send a request to the URL of the web page 102. Upon receiving a response from the web page 102, the proxy node(s) 216 return the response to the proxy router 214, which returns the response to the storm crawler 202. If the storm crawler 202 instead uses JavaScript (JS), the storm crawler sends a request to a JS crawling router 206 to obtain the URL content. To do so, the JS crawling router 206 sends a request to the one or more JS crawling crawlers 208. The one or more JS crawling crawlers 208 open a GOOGLE CHROME instance and causes the instance to go to the desired URL, waiting for all web page content (e.g., Hypertext Markup Language (HTML), JavaScript, Cascading Style Sheets (CSS), images, etc.) to load. Upon receiving the desired data, the one or more JS crawling crawlers 208 return the response to the JS crawling router 206, which returns the response to the storm crawler 202.

Regardless of whether the storm crawler 202 uses a proxy or uses JavaScript, upon receiving the response the storm crawler 202 extracts metadata from the crawling response. The system then saves any new links found, saves video data, and/or detects if a video page can be later downloaded, etc.

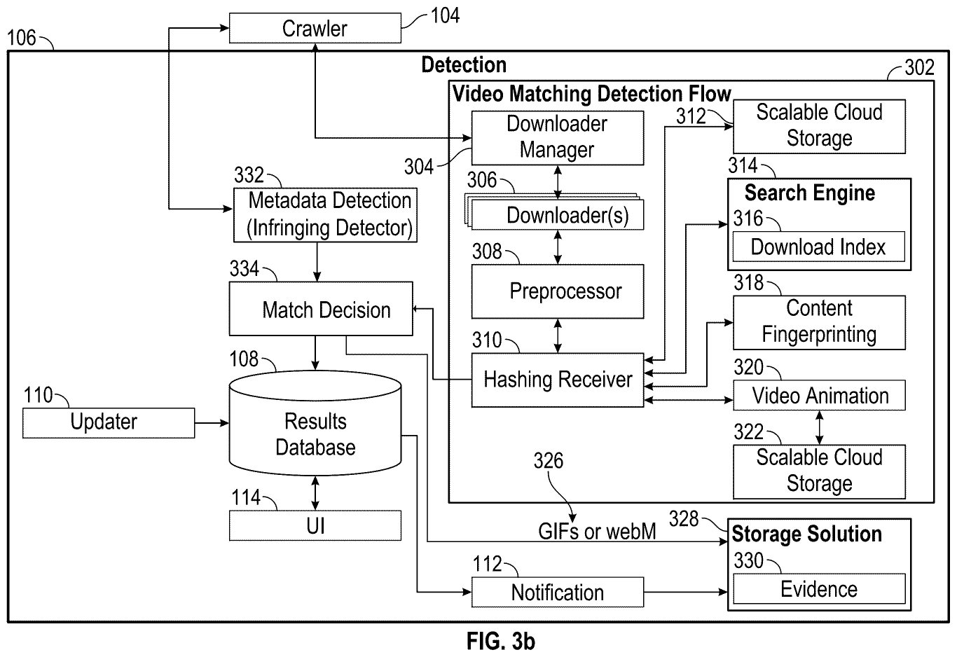

FIG. 3a illustrates a first example of the detection 106 portion of the system. Here, the results from the crawler 104 are received and processed through the video matching detection flow 302 illustrated. The video matching detection flow 302 has a downloader manager 304 which controls which content can be downloaded and when by one or more downloaders 306. The downloaded content is then preprocessed by a preprocessor 308, which can crop, change coloring, or otherwise modify (e.g., process) the content as needed to enable improved recognition of proprietary content. It also computes fingerprints so they can be used in the query downstream. The results of this processing are input to a hashing receiver 310, which receives the pre-processed videos and causes comparison of the content (i.e., using fingerprints of current content to fingerprints of previously known content). The hashing receiver 310 also interacts with (1) scalable cloud storage 312; (2) a search engine 314 (e.g., a distributed, multitenant-capable full-text search engine with a Hypertext Transfer Protocol (HTTP) web interface and schema-free JavaScript Object Notation (JSON) documents, such as but not limited to ELASTICSEARCH) and download index 316 (i.e., the content from the crawler 104 that needed to be analyzed); (3) content fingerprinting 318 (i.e., the pre-processing); and/or (4) video animation 320 (such as, but not limited to GIFs), which can be stored in a scalable cloud storage 322 (which may or may not be the same scalable cloud storage 312 otherwise illustrated).

The hashing receiver 310 also interacts with a hashing loader 324, which processes the comparison results into an infringement decision. Based on matches, best match, domain settings and global rules, the hashing-loader will decide if a web page is hosting infringing material. The hashing receiver 310 can send proof of infringement (such as GIFs 326) to storage solution 328 (preferably an on-premises storage solution, such as a server or database which can be securely monitored), such that the storage solution 328 has evidence of the infringement. The notifications 112 flow can also interact with the storage solution 328 and/or the evidence 330, such that the notice sent to the infringing domain contains proof of the infringement.

Also illustrated in FIG. 3a is that metadata collected by the crawler 104 can be received by a metadata loader 332, which can detect infringement if titles or other data about the content is sufficiently similar to known content. This metadata can be stored within the results database for future comparisons.

In some configurations, various functions/aspects of FIG. 3a can be combined, allowing for increased centralization of the matching/infringement decision process. For example, in some configurations, the decision processes from the Metadata Loader 332 (Infringing Detector) and Hashing-Loader 324 (for a Video Hash) can be combined into one service to centralize the decision process.

FIG. 3b illustrates a second example of the detection 106 portion of the system. Here, the results from the crawler 104 are similarly received and processed through the video matching detection flow 302 illustrated. The video matching detection flow 302 has a downloader manager 304 which controls which content can be downloaded and when by one or more downloaders 306. The downloaded content is then preprocessed by a preprocessor 308, which can crop, change coloring, or otherwise modify (e.g., process) the content as needed to enable improved recognition of proprietary content. It also computes fingerprints so they can be used in the query downstream. The results of this processing are input to a hashing receiver 310, which receives the pre-processed videos and causes comparison of the content (i.e., using fingerprints of current content to fingerprints of previously known content). The hashing receiver 310 can also interact with (1) scalable cloud storage 312; (2) a search engine 314 (e.g., a distributed, multitenant-capable full-text search engine with a Hypertext Transfer Protocol (HTTP) web interface and schema-free JavaScript Object Notation (JSON) documents, such as but not limited to ELASTICSEARCH) and download index 316 (i.e., the content from the crawler 104 that needed to be analyzed); (3) content fingerprinting 318 (i.e., the pre-processing); and/or (4) video animation 320 (such as, but not limited to WebM video playback and/or GIFs), which can be stored in a scalable cloud storage 322 (which may or may not be the same scalable cloud storage 312 otherwise illustrated).

The hashing receiver 310 also forwards data to the match decision 334, which processes the comparison results into an infringement decision. Based on matches, best match, domain settings and global rules, the match decision 334 will decide if a web page is hosting infringing material. The match decision 334 can send proof of infringement (such as WebM or GIFs 326)

to a storage solution 328 (preferably an on-premises storage solution, such as a server or database which can be securely monitored), such that the storage solution 328 has evidence of the infringement. The notifications 112 flow can also interact with the storage solution 328 and/or the evidence 330, such that the notice sent to the infringing domain contains proof of the infringement.

Also illustrated in FIG. 3b is that metadata collected by the crawler 104 can be received by a metadata detection 332, which can detect infringement if titles or other data about the content is sufficiently similar to known content. This metadata can be stored within the results database for future comparisons.

In some configurations, various functions/aspects of FIG. 3b can be combined, allowing for increased centralization of the matching/infringement decision process. For example, in some configurations, the decision processes from the Metadata Detection 332 (aka Infringing Detector) and Hash Detection 324 (for a Video Hash) can be combined into one service to centralize the decision process. Likewise, as illustrated, the outputs of the Metadata Detection 332 and the Hash Detection 324 can be used together to determine (Match Decision 334) if a match is found. The results of that match decision 334 can be stored in the results database 108.

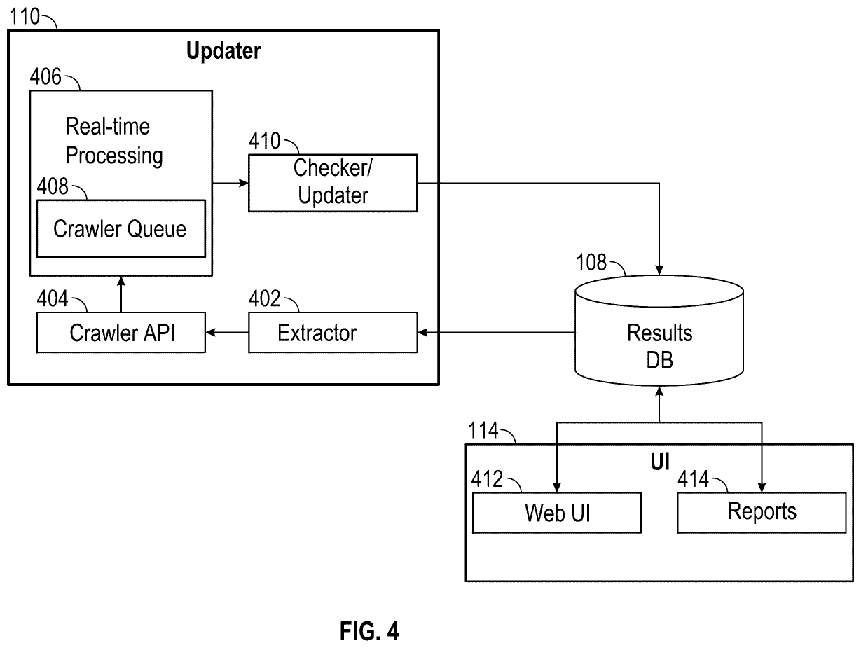

FIG. 4 illustrates an example of the updater 110 and user interface 114 portions of the system. When the system finds URLs containing infringing content, the system regularly checks to see if the URLs are still valid (i.e., if the web page still exists, and if it still contains the infringing content). This avoids sending email notices for URLs that are already deactivated, and to monitor that URLs stay deactivated once the email notice is sent and acknowledged. As illustrated, the updater 110 has an extractor 402, which uses a crawler API 404, which verifies if previously identified content is still present. The data from the crawler API 404 is then used for real-time processing 406 which includes a crawler queue 408, where the system can store messages (e.g., places/domains to be searched) by the web crawler. The results from this are sent to a checker/updater 410, which can update the information stored in the results DB 108 upon verifying that the infringing material has been removed. Once the material is removed, the checker/updated 410 can continue to monitor to be sure that the content is not reuploaded later. Rules and checking intervals can be configured on a per domain basis.

With respect to the user interface (UI) 114, the results DB 108 can send the comparison results to a web user interface (UI) 412 and/or to a report 414 which can be sent to a user for review.

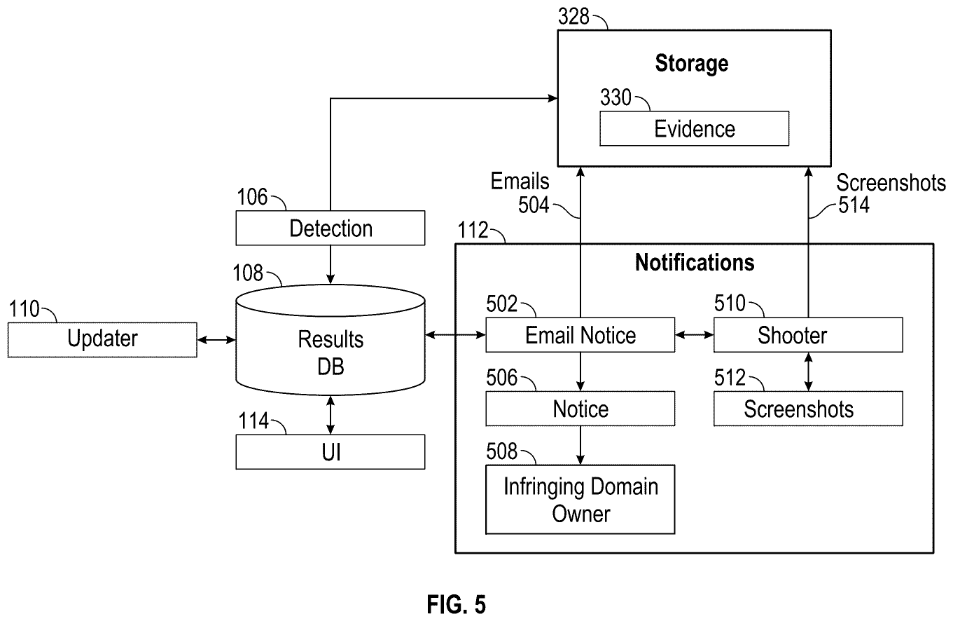

FIG. 5 illustrates an example of the notifications 112 portion of the system. As illustrated, the system generates an email notice 502 which is sent (i.e., notice 506 provided) to the infringing domain owner 508. The email notice 502 can also work with a shooter 510 to capture screenshots 512 of the infringing content. The notifications 112 portion can forward emails 504 generated and screenshots 514 captured by the shooter 510. As illustrated, the shooter 510 controls the software tool which performs the screen capture, with the shooter 510 being a physical part of the system. In other configurations, the shooter 510 can be deployed in the cloud, allowing for scalability.

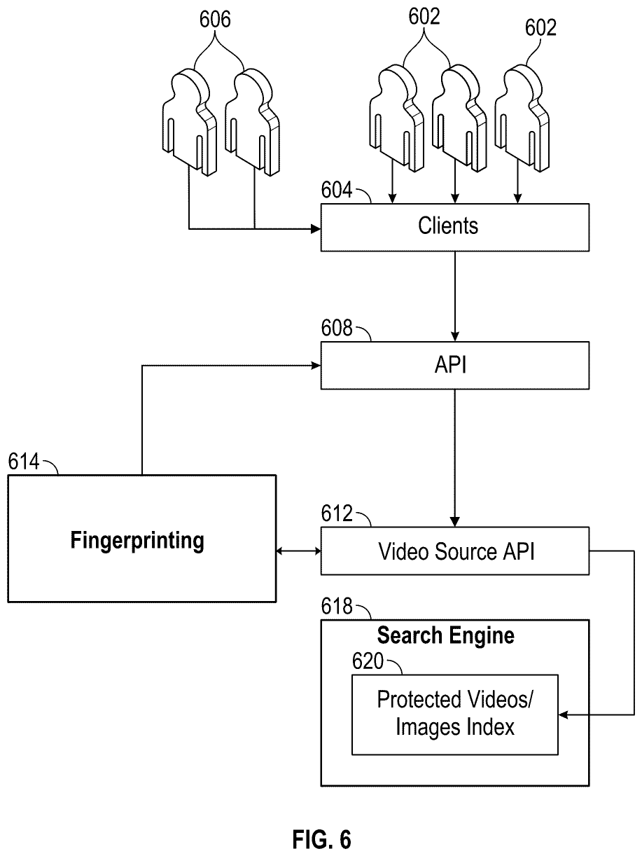

FIG. 6 illustrates an example of an ingestion flow to the system. As illustrated, a number of collections 602 have their content uploaded to clients 604 (e.g., websites that require a membership to access), while other collections 606 are not linked to clients 604. The information from the respective collections 602, 606 is retrieved via an Application Programming Interface (API) 608, which is then used to download (via a video source API 612) the content in question. In some configurations, the video source API 612 can use an event driven function (such as receiving a notification that new content has been uploaded to a website) to initiate the download. The results of the download can then be used by a search engine 618 (including protected videos/image index 620) for future identification of infringing content. In addition, as illustrated, the results of the download can be used for fingerprinting 614, allowing detection of infringing content. Video content which needs protection is sent to the video source API 612 (which needs to be configured to receive said content from said new brand or collection of content). The content information can be sent to the fingerprinting 614 engine (e.g., for fingerprinting a new video and saving the newly generated fingerprint into a database of protected content), and the corresponding content information (collection, brand, owner, identification, etc.) is saved into a search engine database.

If the brand of the video (i.e., the entity that created the video), an owner of the video, and/or an owner of a video collection has allowed the owner of the system to perform backscans (i.e., reviewing fingerprints of previously identified content to determine if the previously identified content infringes on the newly fingerprinted content), the fingerprinting 614 engine can perform a backscan and inform the video source API 612 that matches have been found (or not). If matches were found, the matching URLs will be set as “to be redownloaded” so that the whole detection flow can be re-triggered, thereby ensuring that said URL is still valid and it still hosts the infringing content.

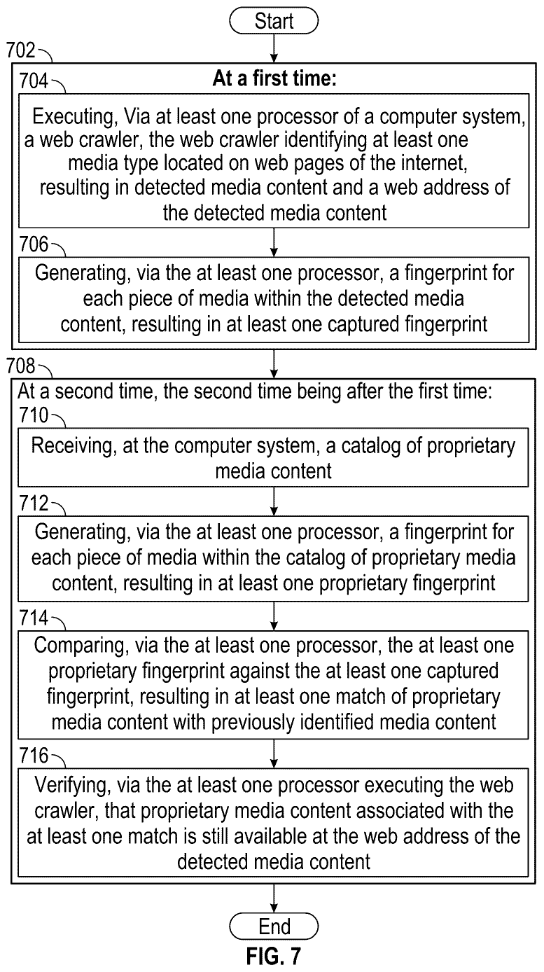

FIG. 7 illustrates an example method embodiment which can be performed by a system, such as a computer system. As illustrated, at a first time (702), the system executes, via at least one processor of a computer system, a web crawler, the web crawler identifying at least one media type located on web pages of the Internet, resulting in detected media content and a web address of the detected media content (704) and generates, generating, via the at least one processor, a fingerprint for each piece of media within the detected media content, resulting in at least one captured fingerprint (706). Then, at a second time, the second time being after the first time (708), the system receives a catalog of proprietary media content (710). The system then generates, via the at least one processor, a fingerprint for each piece of media within the catalog of proprietary media content, resulting in at least one proprietary fingerprint (712) and compares, via the at least one processor, the at least one proprietary fingerprint against the at least one captured fingerprint, resulting in at least one match of proprietary media content with previously identified media content (714). In some instances, the system may return no matched content (i.e., not every page crawled results in protected content). The system then verifies, via the at least one processor executing the web crawler, that proprietary media content associated with the at least one match is still available at the web address of the detected media content (716).

In some configurations, the illustrated method can further include: generating a communication to an owner of the web address informing the owner that the proprietary media content associated with the at least one match is still available at the web address of the detected media content. Such configurations can be still further expanded to include: generating, via the at least one processor based on the at least one match, a Graphics Interchange Format (GIF) for each match in the at least one match, resulting in at least one GIF, the at least one GIF illustrating the at least one match, wherein the communication further comprises the at least one GIF.

In some configurations, the fingerprint of each piece of media comprises a perceptual hash.

In some configurations, identification of the at least one match can be based on the at least one proprietary fingerprint being within a predetermined percentage of similarity with the at least one captured fingerprint. For example, the predetermined percentage of similarity can be at least ten percent similarity of video or twenty percent similarity of audio.

In some configurations, execution of the web crawler to identify the at least one of images or videos can include: a priority crawl which is executed periodically on a specific web page to identify newly uploaded content; and a general crawl which, when executed, crawls all web pages associated with a domain.

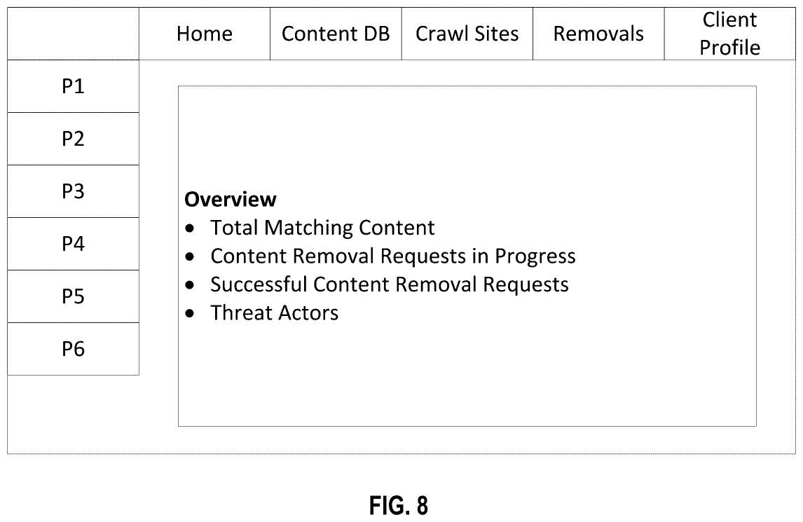

FIG. 8 illustrates an example view of a dashboard for using the system.

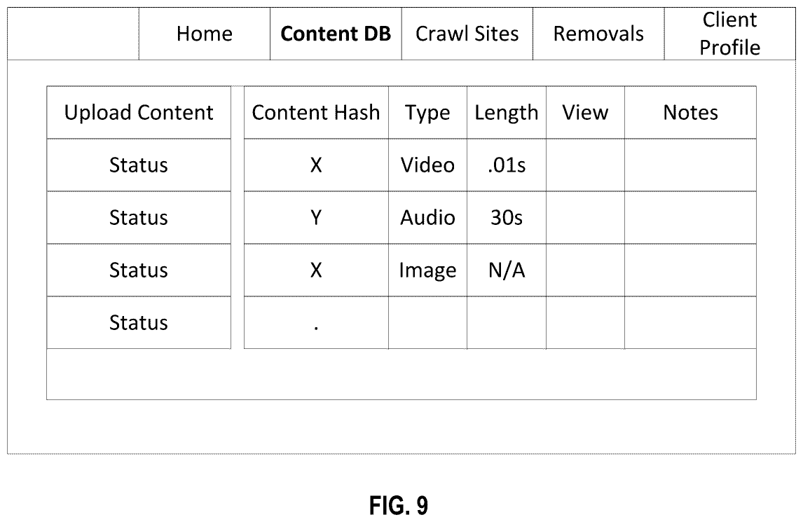

FIG. 9 illustrates an example view of the content database tab in the dashboard.

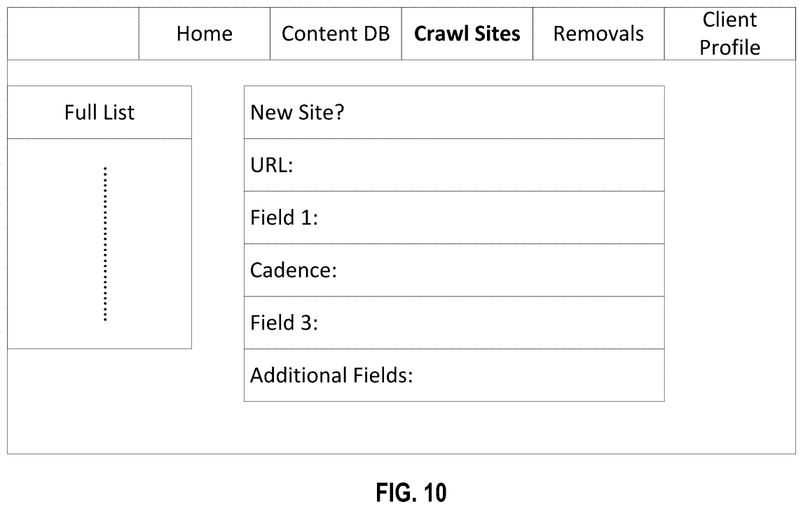

FIG. 10 illustrates an example view of the crawl sites tab in the dashboard.

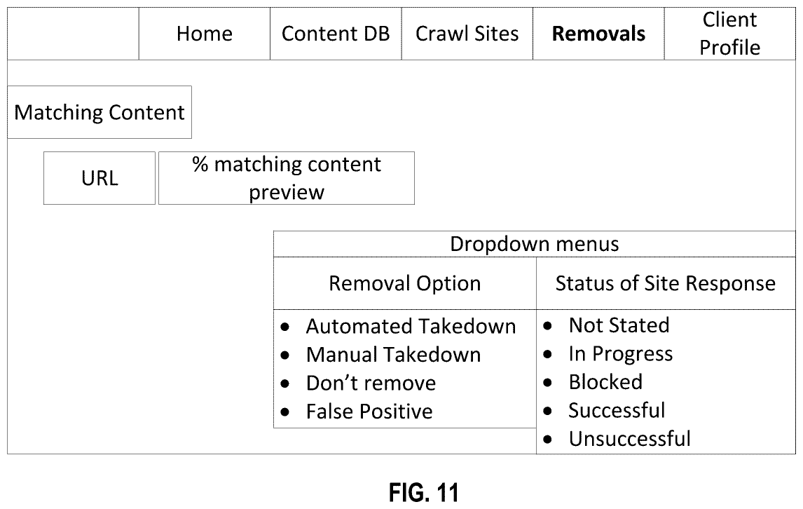

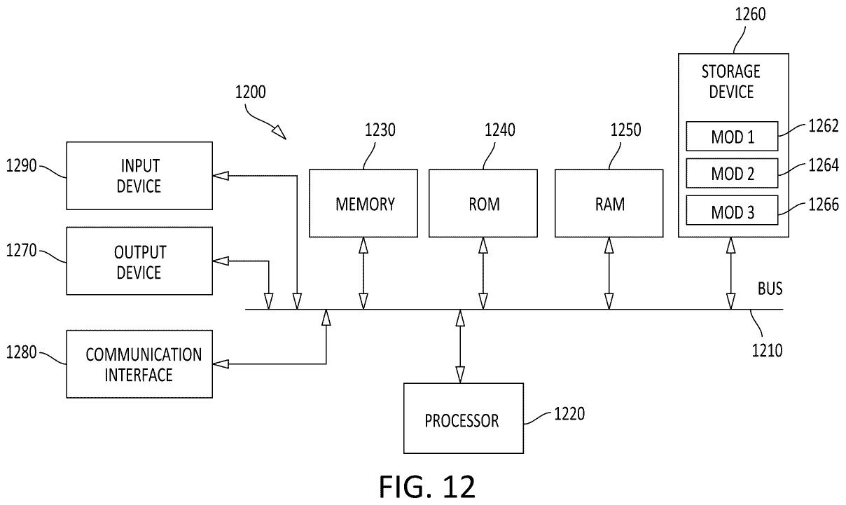

FIG. 11 illustrates an example view of the removal tab in the dashboard. With reference to FIG. 12, an exemplary system includes a computing device 1200 (such as a general-purpose computing device), including a processing unit (CPU or processor) 1220 and a system bus 1210 that couples various system components including the system memory 1230 such as read-only memory (ROM) 1240 and random access memory (RAM) 1250 to the processor 1220. The computing device 1200 can include a cache of high-speed memory connected directly with, in close proximity to, or integrated as part of the processor 1220. The computing device 1200 copies data from the system memory 1230 and/or the storage device 1260 to the cache for quick access by the processor 1220. In this way, the cache provides a performance boost that avoids processor 1220 delays while waiting for data. These and other modules can control or be configured to control the processor 1220 to perform various actions. Other system memory 1230 may be available for use as well. The system memory 1230 can include multiple different types of memory with different performance characteristics. It can be appreciated that the disclosure may operate on a computing device 1200 with more than one processor 1220 or on a group or cluster of computing devices networked together to provide greater processing capability. The processor 1220 can include any general-purpose processor and a hardware module or software module, such as module 1 1262, module 2 1264, and module 3 1266 stored in storage device 1260, configured to control the processor 1220 as well as a special-purpose processor where software instructions are incorporated into the actual processor design. The processor 1220 may essentially be a completely self-contained computing system, containing multiple cores or processors, a bus, memory controller, cache, etc. A multi-core processor may be symmetric or asymmetric.

The system bus 1210 may be any of several types of bus structures including a memory bus or memory controller, a peripheral bus, and a local bus using any of a variety of bus architectures. A basic input/output (BIOS) stored in memory ROM 1240 or the like, may provide the basic routine that helps to transfer information between elements within the computing device 1200, such as during start-up. The computing device 1200 further includes storage devices 1260 such as a hard disk drive, a magnetic disk drive, an optical disk drive, tape drive or the like. The storage device 1260 can include software modules 1262, 1264, 1266 for controlling the processor 1220. Other hardware or software modules are contemplated. The storage device 1260 is connected to the system bus 1210 by a drive interface. The drives and the associated computer-readable storage media provide nonvolatile storage of computer-readable instructions, data structures, program modules and other data for the computing device 1200. In one aspect, a hardware module that performs a particular function includes the software component stored in a tangible computer-readable storage medium in connection with the necessary hardware components, such as the processor 1220, system bus 1210, output device 1270 (such as a display or speaker), and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 1200 is a small, handheld computing device, a desktop computer, or a computer server.

Although the exemplary embodiment described herein employs the storage device 1260 (such as a hard disk), other types of computer-readable media which can store data that are accessible by a computer, such as magnetic cassettes, flash memory cards, digital versatile disks, cartridges, random access memories (RAMs) 1250, and read-only memory (ROM) 1240, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 1200, an input device 1290 represents any number of input mechanisms, such as a microphone for speech, a touch-sensitive screen for gesture or graphical input, keyboard, mouse, motion input, speech and so forth. An output device 1270 can also be one or more of a number of output mechanisms known to those of skill in the art. In some instances, multimodal systems enable a user to provide multiple types of input to communicate with the computing device 1200. The communications interface 1280 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A method comprising: at a first time: executing, via at least one processor of a computer system, a web crawler, the web crawler identifying at least one media type located on web pages of the Internet, resulting in detected media content and a web address of the detected media content; generating, via the at least one processor, a fingerprint for each piece of media within the detected media content, resulting in at least one captured fingerprint; and at a second time, the second time being after the first time: receiving, at the computer system, a catalog of proprietary media content; generating, via the at least one processor, a fingerprint for each piece of media within the catalog of proprietary media content, resulting in at least one proprietary fingerprint; comparing, via the at least one processor, the at least one proprietary fingerprint against the at least one captured fingerprint, resulting in at least one match of proprietary media content with previously identified media content; and verifying, via the at least one processor executing the web crawler, that proprietary media content associated with the at least one match is still available at the web address of the detected media content. In some instances, the system may return no matched content (i.e., not every page crawled results in protected content).

The method of any preceding clause, further comprising: generating a communication to an owner of the web address informing the owner that the proprietary media content associated with the at least one match is still available at the web address of the detected media content.

The method of any preceding clause, further comprising: generating, via the at least one processor based on the at least one match, a Graphics Interchange Format (GIF) for each match in the at least one match, resulting in at least one GIF, the at least one GIF illustrating the at least one match, wherein the communication further comprises the at least one GIF.

The method of any preceding clause, wherein the fingerprint of each piece of media comprises a perceptual hash.

The method of any preceding clause, wherein identification of the at least one match is based on the at least one proprietary fingerprint being within a predetermined percentage of similarity with the at least one captured fingerprint.

The method of any preceding clause, wherein the at least one media type comprises videos.

The method of any preceding clause, wherein the at least one media type comprises images.

The method of any preceding clause, wherein execution of the web crawler to identify the at least one media type comprises: a priority crawl which is executed periodically on a specific web page to identify newly uploaded content; and a general crawl which, when executed, crawls all web pages associated with a domain.

A system comprising: at least one processor; and a non-transitory computer-readable storage medium having instructions stored which, when executed by the at least one processor, cause the at least one processor to perform operations comprising: at a first time: executing a web crawler, the web crawler identifying at least one media type located on web pages of the Internet, resulting in detected media content and a web address of the detected media content; generating a fingerprint for each piece of media within the detected media content, resulting in at least one captured fingerprint; and at a second time, the second time being after the first time: receiving a catalog of proprietary media content; generating a fingerprint for each piece of media within the catalog of proprietary media content, resulting in at least one proprietary fingerprint; comparing the at least one proprietary fingerprint against the at least one captured fingerprint, resulting in at least one match of proprietary media content with previously identified media content; and verifying, by executing the web crawler, that proprietary media content associated with the at least one match is still available at the web address of the detected media content. In some instances, the system may return no matched content (i.e., not every page crawled results in protected content).

The system of any preceding clause, the non-transitory computer-readable storage medium having additional instructions stored which, when executed by the at least one processor, cause the at least one processor to perform operations comprising: generating a communication to an owner of the web address informing the owner that the proprietary media content associated with the at least one match is still available at the web address of the detected media content.

The system of any preceding clause, the non-transitory computer-readable storage medium having additional instructions stored which, when executed by the at least one processor, cause the at least one processor to perform operations comprising: generating, via the at least one processor based on the at least one match, a Graphics Interchange Format (GIF) for each match in the at least one match, resulting in at least one GIF, the at least one GIF illustrating the at least one match, wherein the communication further comprises the at least one GIF.

The system of any preceding clause, wherein the fingerprint of each piece of media comprises a perceptual hash.

The system of any preceding clause, wherein identification of the at least one match is based on the at least one proprietary fingerprint being within a predetermined percentage of similarity with the at least one captured fingerprint.

The system of any preceding clause, wherein execution of the web crawler to identify the at least one media type comprises: a priority crawl which is executed periodically on a specific web page to identify newly uploaded content; and a general crawl which, when executed, crawls all web pages associated with a domain.

A non-transitory computer-readable storage medium having instructions stored which, when executed by at least one processor, cause the at least one processor to perform operations comprising: at a first time: executing a web crawler, the web crawler identifying at least one media type located on web pages of the Internet, resulting in detected media content and a web address of the detected media content; generating a fingerprint for each piece of media within the detected media content, resulting in at least one captured fingerprint; and at a second time, the second time being after the first time: receiving a catalog of proprietary media content; generating a fingerprint for each piece of media within the catalog of proprietary media content, resulting in at least one proprietary fingerprint; comparing the at least one proprietary fingerprint against the at least one captured fingerprint, resulting in at least one match of proprietary media content with previously identified media content; and verifying, by executing the web crawler, that proprietary media content associated with the at least one match is still available at the web address of the detected media content. In some instances, the system may return no matched content (i.e., not every page crawled results in protected content).

The non-transitory computer-readable storage medium of any preceding clause, having additional instructions stored which, when executed by the at least one processor, cause the at least one processor to perform operations comprising: generating a communication to an owner of the web address informing the owner that the proprietary media content associated with the at least one match is still available at the web address of the detected media content.

The non-transitory computer-readable storage medium of any preceding clause, having additional instructions stored which, when executed by the at least one processor, cause the at least one processor to perform operations comprising: generating, via the at least one processor based on the at least one match, a Graphics Interchange Format (GIF) for each match in the at least one match, resulting in at least one GIF, the at least one GIF illustrating the at least one match, wherein the communication further comprises the at least one GIF.

The non-transitory computer-readable storage medium of any preceding clause, wherein the fingerprint of each piece of media comprises a perceptual hash.

The non-transitory computer-readable storage medium of any preceding clause, wherein identification of the at least one match is based on the at least one proprietary fingerprint being within a predetermined percentage of similarity with the at least one captured fingerprint.

The non-transitory computer-readable storage medium of any preceding clause, wherein the at least one media type comprises videos.

We claim:

1. A method comprising:
at a first time:
executing, via at least one processor of a computer system, a web crawler, the web crawler identifying at least one media type located on web pages of the Internet, resulting in detected media content and a web address of the detected media content;
generating, via the at least one processor, a fingerprint for each piece of media within the detected media content, resulting in at least one captured fingerprint; and at a second time, the second time being after the first time:
receiving, at the computer system, a catalog of proprietary media content;
generating, via the at least one processor, a fingerprint for each piece of media within the catalog of proprietary media content, resulting in at least one proprietary fingerprint;
comparing, via the at least one processor, the at least one proprietary fingerprint against the at least one captured fingerprint, resulting in at least one match of proprietary media content with previously identified media content; and
verifying, via the at least one processor executing the web crawler, that proprietary media content associated with the at least one match is still available at the web address of the detected media content.

2. The method of claim 1, further comprising:
generating a communication to an owner of the web address informing the owner that the proprietary media content associated with the at least one match is still available at the web address of the detected media content.

3. The method of claim 2, further comprising:
generating, via the at least one processor based on the at least one match, a Graphics Interchange Format (GIF) for each match in the at least one match, resulting in at least one GIF, the at least one GIF illustrating the at least one match,
wherein the communication further comprises the at least one GIF.

4. The method of claim 1, wherein the fingerprint of each piece of media comprises a perceptual hash.

5. The method of claim 1, wherein identification of the at least one match is based on the at least one proprietary fingerprint being within a predetermined percentage of similarity with the at least one captured fingerprint.

6. The method of claim 1, wherein the at least one media type comprises videos.

7. The method of claim 1, wherein the at least one media type comprises images.

8. The method of claim 1, wherein execution of the web crawler to identify the at least one media type comprises:
a priority crawl which is executed periodically on a specific web page to identify newly uploaded content; and
a general crawl which, when executed, crawls all web pages associated with a domain.

9. A system comprising:
at least one processor; and
a non-transitory computer-readable storage medium having instructions stored which, when executed by the at least one processor, cause the at least one processor to perform operations comprising:
at a first time:
executing a web crawler, the web crawler identifying at least one media type located on web pages of the Internet, resulting in detected media content and a web address of the detected media content;
generating a fingerprint for each piece of media within the detected media content, resulting in at least one captured fingerprint; and at a second time, the second time being after the first time:
receiving a catalog of proprietary media content;
generating a fingerprint for each piece of media within the catalog of proprietary media content, resulting in at least one proprietary fingerprint;
comparing the at least one proprietary fingerprint against the at least one captured fingerprint, resulting in at least one match of proprietary media content with previously identified media content; and
verifying, by executing the web crawler, that proprietary media content associated with the at least one match is still available at the web address of the detected media content.

10. The system of claim 9, the non-transitory computer-readable storage medium having additional instructions stored which, when executed by the at least one processor, cause the at least one processor to perform operations comprising:
generating a communication to an owner of the web address informing the owner that the proprietary media content associated with the at least one match is still available at the web address of the detected media content.

11. The system of claim 10, the non-transitory computer-readable storage medium having additional instructions stored which, when executed by the at least one processor, cause the at least one processor to perform operations comprising:
generating, via the at least one processor based on the at least one match, a Graphics Interchange Format (GIF) for each match in the at least one match, resulting in at least one GIF, the at least one GIF illustrating the at least one match,
wherein the communication further comprises the at least one GIF.

12. The system of claim 9, wherein the fingerprint of each piece of media comprises a perceptual hash.

13. The system of claim 9, wherein identification of the at least one match is based on the at least one proprietary fingerprint being within a predetermined percentage of similarity with the at least one captured fingerprint.

14. The system of claim 9, wherein execution of the web crawler to identify the at least one media type comprises:
a priority crawl which is executed periodically on a specific web page to identify newly uploaded content; and
a general crawl which, when executed, crawls all web pages associated with a domain.

15. A non-transitory computer-readable storage medium having instructions stored which, when executed by at least one processor, cause the at least one processor to perform operations comprising:
at a first time:
executing a web crawler, the web crawler identifying at least one media type located on web pages of the Internet, resulting in detected media content and a web address of the detected media content;
generating a fingerprint for each piece of media within the detected media content, resulting in at least one captured fingerprint; and
at a second time, the second time being after the first time:
receiving a catalog of proprietary media content;
generating a fingerprint for each piece of media within the catalog of proprietary media content, resulting in at least one proprietary fingerprint;
comparing the at least one proprietary fingerprint against the at least one captured fingerprint, resulting in at least one match of proprietary media content with previously identified media content; and
verifying, by executing the web crawler, that proprietary media content associated with the at least one match is still available at the web address of the detected media content.

16. The non-transitory computer-readable storage medium of claim 15, having additional instructions stored which, when executed by the at least one processor, cause the at least one processor to perform operations comprising:
generating a communication to an owner of the web address informing the owner that the proprietary media content associated with the at least one match is still available at the web address of the detected media content.

17. The non-transitory computer-readable storage medium of claim 16, having additional instructions stored which, when executed by the at least one processor, cause the at least one processor to perform operations comprising:
generating, via the at least one processor based on the at least one match, a Graphics Interchange Format (GIF) for each match in the at least one match, resulting in at least one GIF, the at least one GIF illustrating the at least one match,
wherein the communication further comprises the at least one GIF.

18. The non-transitory computer-readable storage medium of claim 15, wherein the fingerprint of each piece of media comprises a perceptual hash.

19. The non-transitory computer-readable storage medium of claim 15, wherein identification of the at least one match is based on the at least one proprietary fingerprint being within a predetermined percentage of similarity with the at least one captured fingerprint.

20. The non-transitory computer-readable storage medium of claim 19, wherein the at least one media type comprises videos.
